(19) United States
(12) Patent Application Publication
(10) Pub. No.: US 2012/0174019 A1
(43) Pub. Date: Jul. 5, 2012

(54) ELECTRONIC DEVICE WITH TYPING PROMPT FUNCTION AND TYPING PROMPT METHOD THEREOF

(75) Inventor: CHI-SHENG GE, Tu-Cheng (TW)

(73) Assignee: HON HAI PRECISION INDUSTRY CO., LTD., Tu-Cheng (TW)

(21) Appl. No.: 13/108,975

(22) Filed: May 16, 2011

(30) Foreign Application Priority Data
Dec. 31, 2010 (TW) 99147176

(51) Int. Cl. G06F 3/048

(52) U.S. Cl. 715/773

(57) ABSTRACT

An electronic device includes a touch-sensitive screen which displays a virtual keyboard. The virtual keyboard includes a number of virtual letter keys. The electronic device further employs a predictive text function to predict which word a user is typing and prompts the user which letters can be entered next to form a proper word by changing the display status of the corresponding possible virtual letter keys, such as changing the size or the brightness of the possible virtual letters labeled on the virtual letter keys. Therefore, under such input prompt on the possible virtual letter keys, the user can quickly and correctly enter data. A related typing prompt method is also provided.

### BACKGROUND

1. Technical Field

The present disclosure relates to electronic devices and, particularly, to a touch-sensitive electronic device with typing prompt function and a typing prompt method.

2. Description of Related Art

A standard keyboard of a touch-sensitive electronic device has many keys, and it may be difficult for users who are not familiar with the arrangement of the keys to enter data quickly and correctly, especially during word processing.

Therefore, what is needed is an electronic device that can assist users in correctly entering data via a touch input keyboard.

### BRIEF DESCRIPTION OF THE DRAWINGS

The components of the drawings are not necessarily drawn to scale, the emphasis instead being placed upon clearly illustrating the principles of an electronic device with typing prompt function. Moreover, in the drawings, like reference numerals designate corresponding parts throughout several views.

FIG. 1 is a block diagram of an electronic device with typing prompt function, in accordance with an exemplary embodiment.

FIG. 2 is a schematic view of a touch input screen of the electronic device of FIG. 1 in accordance with an exemplary embodiment.

FIGS. 3A and 3B are a flowchart of a typing prompt method implemented by the electronic device of FIG. 1, in accordance with an exemplary embodiment.

### DETAILED DESCRIPTION

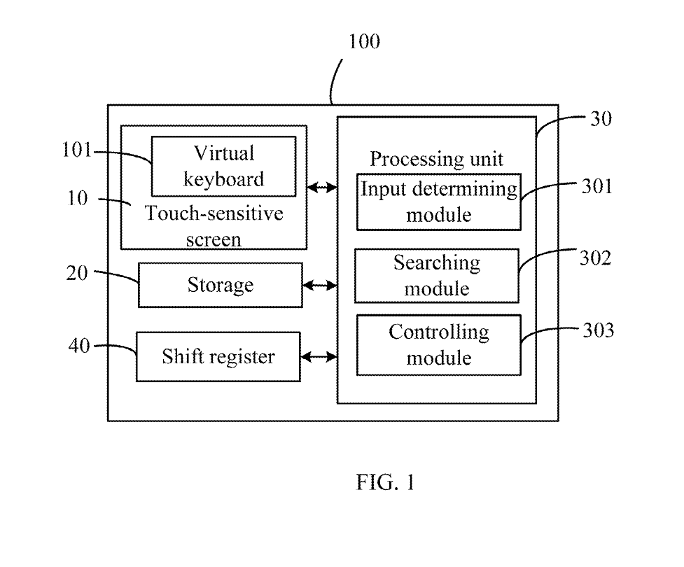

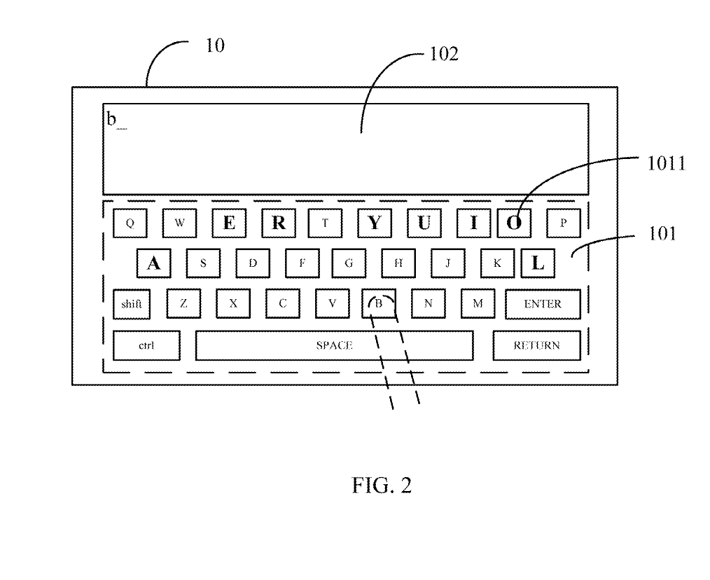

Referring to FIGS. 1-2, an electronic device 100 includes a touch-sensitive screen 10. The electronic device 100 can display a virtual keyboard 101 to receive user input, and a display window 102 to display input data. The virtual keyboard 101 includes a number of virtual keys 1011 each of which is labeled with an icon. The icon on each virtual key 1011 is used to indicate a key value input associated with the corresponding virtual key. For example, in the embodiment as shown in FIG. 2, the virtual keys 1011 include a number of virtual letter keys 1011 labeled A-Z. The electronic device 100 further employs a predictive text function to predict which word the user is typing and prompts the user which letters can be entered next to form a proper word by changing the display status of the corresponding possible virtual letter keys 1011. Such as changing the size or the brightness of the possible virtual letters labeled on the virtual letter keys 1011, using such input prompt on the possible virtual letter keys 1011, the user can quickly and correctly enter data. In this embodiment, a special key (not shown) is further arranged on the keyboard 101 for starting the input prompt function. In other embodiments, the electronic device 100 automatically activates the typing prompt function when powered up, without the special key.

In this embodiment, the electronic device 100 further includes a storage 20, a processing unit 30, and a shift register 40. The processing unit 30 further includes an input determining module 301, a searching module 302, and a controlling module 303.

The storage 20 is configured for storing at least one dictionary corresponding to a character input method. For the dictionary corresponding to a character input method, it includes a number of words, and each of the words includes the key value of at least one letter. The storage 20 further stores relationships between the key values and the virtual keys 1011. The shift register 40 is configured for storing the key value of the input of each touched virtual letter key 1011.

The input determining module 301 is configuring for detecting which virtual key 1011 is touched, and determining the key value of the touched virtual key 1011 according to the relationships between the key values and the virtual keys stored in the storage 20. The input determining module 301 is further configured for storing the key value of the input of the touched virtual letter key 1011 to the shift register 40.

The searching module 302 is configured for searching in the dictionary corresponding to the character input method in use to predict which word the user is typing and determine whether at least one key value is possible as a next input to form a word from the dictionary according to the key value stored in the shift register 40.

The controlling module 303 is configured for controlling the display status of the virtual letter keys 1011 to be in a first display status initially, such as the size and the brightness of the letters labeled on the virtual letter keys 1011 are displayed in a standard status. The controlling module 303 is further configured for changing the display status of at least one virtual letter key 1011 which key value is the at least one key value found by the searching module 302. In this embodiment, the controlling module 303 changes the display status of the at least one virtual letter key 1011 to a second status. For example, the controlling module 303 enlarges the size of the label or highlights the label on the at least one virtual letter key 1011. The controlling module 303 is further configured for displaying input in the display window 102. An example is given to better illustrate the present disclosure. When a word “best” is to be input, a letter “b” is input first. The input determining module 301 determines the key value of “b” and stores the key value “b” to the shift register 40. The searching module 302 searches in the dictionary corresponding to the English input method according to the key value of “b” stored in the shift register 40 and finds the key values of “a”, “e”, “i”, “l”, “o”, “r”, “u”, “y” are possible as a next input to form a word. Then the controlling module 303 enlarges the size of the labels “a”, “e”, “i”, “l”, “o”, “r”, “u”, “y” on the corresponding virtual letter keys 1011.

The controlling module 303 is further configured for controlling all the virtual letter keys 1011 to the first state once the input determining module 301 determines a confirm key (not shown) is touched. At the same time, the controlling module 303 deletes all the key values stored in the shift register 40. In the exemplary embodiment, when the confirm key is touched, a word is input to the electronic device 100.

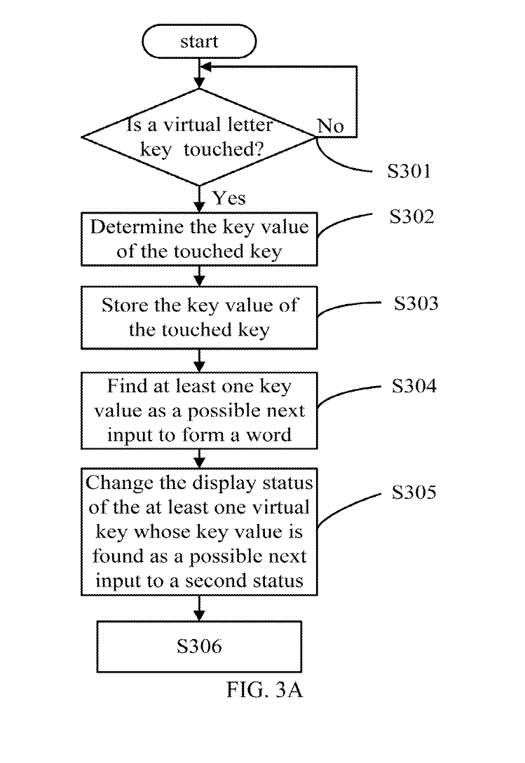

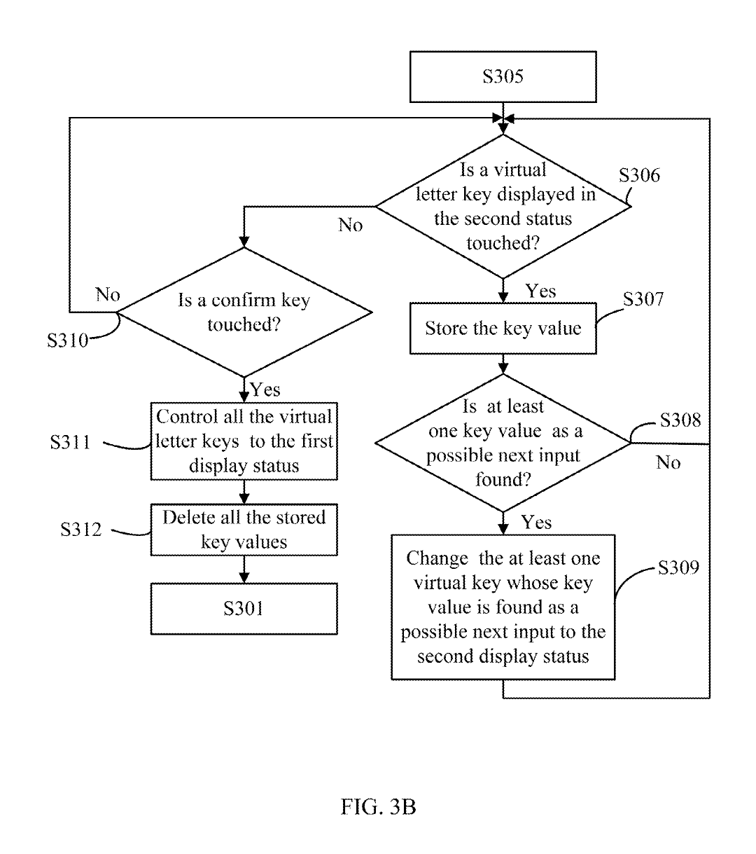

FIGS. 3A and 3B are a flowchart of a typing prompt method implemented by the electronic device 100 of FIG. 1, in accordance with an exemplary embodiment.

In step S301, the input determining module 301 determines whether one of the virtual letter keys 1011 is touched. If yes, the procedure goes to step S302, otherwise the input determining module 301 continues to determine whether a virtual letter key 1011 is touched.

In an alternative embodiment, the input determining module 301 determines whether a virtual letter key 1011 is touched until the special key (not shown) is touched.

In step S302, the input determining module 301 determines the key value of the touched virtual letter key 1011 according to the relationships between the key values and the virtual letter keys stored in the storage 20.

In step S303, the input determining module 301 stores the key value to the shift register 40.

In step S304, the searching module 302 searches in the dictionary corresponding to the character input method in use to predict which word the user is typing and finds at least one key value as a possible next input to form the word from the dictionary according to the key value stored in the shift register 40.

In step S305, the controlling module 303 changes the display status of the at least one virtual letter key 1011 whose key value is the at least one found key value to a second status.

In step S306, the input determining module 301 determines whether a virtual letter key 1011 displayed in the second status is touched. If yes, the procedure goes to step S307, otherwise the procedure goes to step S310.

In step S307, the input determining module 301 stores the key value of the touched virtual letter key 1011 to the shift register 40.

In step S308, the searching module 302 searches the dictionary corresponding to the character input method in use to predict which word the user is typing and determine whether at least one key value exists as a possible next input towards typing the word from the dictionary. If no such key value is found, the procedure goes to step S306, otherwise the procedure goes to step 309.

In step S309, the controlling module 303 changes the display status of the at least one virtual letter key 1011 which key value is the at least one found key value. After executing step S309, the procedure goes to step S306.

In step S310, the input determining module 301 determines whether a confirm key is touched. If yes, the procedure goes to step S311, otherwise the procedure goes to step S306. In the exemplary embodiment, when a confirm key is touched, a word is input to the electronic device 100.

In step S311, the controlling module 303 controls all the virtual letter keys 1011 to the first display status.

In step S312, the controlling module 303 deletes all the key values stored in the shift register 40. After executing step S312, the procedure goes to step S301.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device with typing prompt function, comprising:
a touch-sensitive screen to generate a virtual keyboard, wherein the virtual keyboard comprises a plurality of virtual keys, and the virtual keys comprise a plurality of virtual letter keys;
a storage configured for storing at least one dictionary corresponding to a character input method, and relationships between the virtual keys and key values, wherein the dictionary comprises a plurality of words and each of the words comprises at least one key value corresponding to one of the virtual letter keys input;
a shift register configured for storing the key values of the virtual letter keys input; and
a processing unit comprising:
an input determining module configured for detecting which virtual key is touched, and determining the key value of the touched virtual key according to the relationships between the key values and the virtual keys stored in the storage and storing the key value of the currently touched virtual key input to the shift register;
a searching module configured for searching in the dictionary corresponding to the character input method to predict which word a user is typing and find at least one key value as a possible next input to form a proper word from the dictionary according to the stored key value in the shift register; and
a controlling module configured for controlling the virtual letter keys displayed in a first display status and changing the display status of the at least one virtual letter key whose key value is the at least one key value found by the searching module to a second status.

2. The electronic device as described in claim 1, wherein the virtual letter keys are labeled A˜Z.

3. The electronic device as described in claim 2, wherein the controlling module changes the size of the labeled letters of the found virtual letter keys to change the display status of the virtual letter keys.

4. The electronic device as described in claim 2, wherein the controlling module changes the brightness of the labeled letters of the searched virtual letter keys to change the display status of the virtual letter keys.

5. The electronic device as described in claim 1, wherein the controlling module is further configured for deleting all the key values stored in the shift register and controlling all the virtual letter keys to be displayed in the first status when the input determining module determines that a confirm key is touched.

6. A typing prompt method comprising:
displaying a virtual keyboard on a touch-sensitive screen, wherein the virtual keyboard comprises a plurality of virtual keys, and the virtual keys comprise a plurality of virtual letter keys;
determining whether one of the virtual letter keys is touched;
determining the key value of the touched virtual letter key and storing the key value;
searching in a provided dictionary corresponding to a character input method to predict which word a user is typing and finding at least one key value as a possible next input to form a proper word from the dictionary according to the key value; and
changing the display status of the at least one virtual letter key whose key value is the at least one found key value.

7. The method as described in claim 6, further comprising:
determining whether a virtual letter key whose display status is changed is touched;
if no such virtual letter key is touched, determining whether a confirm key is touched;
deleting all the stored key values if a confirm key is touched; and
controlling all the virtual keys display to an initial state.

8. The method as described in claim 6, wherein the virtual letter keys are labeled A˜Z.

9. The method as described in claim 6, wherein the change of the display status of the found virtual letter keys is change the size of the labeled letters of the virtual letter key.

10. The method as described in claim 6, wherein the change of the display status of the found virtual letter keys is change the brightness of the labeled letters of the virtual letter key.
